(19) United States
(12) Patent Application Publication
(10) Pub. No.: US 2010/0023854 A1
(43) Pub. Date: Jan. 28, 2010

(54) METHOD AND APPARATUS FOR RECONSTRUCTING A WEB PAGE

(75) Inventor: Dong-hyun SONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics, Co.,Ltd, Suwon-si (KR)

(21) Appl. No.: 12/403,406

(22) Filed: Mar. 13, 2009

(30) Foreign Application Priority Data
Jul. 24, 2008 (KR) 10-2008-0072445

(51) Int. Cl. G06F 17/00

(52) U.S. Cl. 715/234

(57) ABSTRACT

Provided are a method and an apparatus for reconstructing a web page by using a web redefinition document. The method includes receiving an external web document and a web redefining document generated by a user, ‘determining whether attributes of an element in the web document are defined in the web redefining document, deciding on attributes of the element based on the determination, and constructing a web page by using the decided on attributes of the element.

### CROSS-REFERENCE TO RELATED PATENT APPLICATION

This application claims the benefit of Korean Patent Application No. 10-2008-0072445, filed on Jul. 24, 2008, in the Korean Intellectual Property Office, the disclosure of which is incorporated herein in its entirety by reference.

### BACKGROUND OF THE INVENTION

1. Field of the Invention

The present invention relates to construction of a web page and a document for constructing a web page.

2. Description of the Related Art

A web document may define layouts, behaviors, and events of web content to be displayed on a web page by using programming languages such as Hypertext Markup Language (HTML), cascading style sheets (CSS), JavaScript, etc. More particularly, the HTML includes definitions regarding elements of a web page such as anchors, forms, images, etc. JavaScript controls operations with respect to the elements of a web page. CSS defines layout attributes of the elements, such as colors, sizes, etc.

A user may view a web page displayed as provided by a web content creator. For example, portal sites such as Yahoo! and Google provide the same web pages to any user.

### SUMMARY OF THE INVENTION

The present invention provides a method and an apparatus for reconstructing a web page by using a web redefinition document.

According to an aspect of the present invention, there is provided a method of constructing a web page by using a web redefining document, the method comprising receiving an external web document and a web redefining document generated by a user; determining whether a plurality attributes of an element in the web document are defined in the web redefining document; deciding on the attributes of the element based on the determination; and constructing a web page by using the decided on attributes of the element.

The deciding on the attribute of the element may comprise maintaining attributes of the element, if attributes of the element are not defined in the web redefining document.

The decision on the attribute of the element may comprise replacing attributes of the element with attributes defined in the web redefining document, if attributes of the element are defined in the web redefining document.

The decision on the attribute of the element may comprise changing attributes of the element such that the element comprises both attributes defined in the web document and attributes defined in the web redefining document, if attributes of the element are defined in the web redefining document.

The attributes of the element may define at least one of a layout of the element, a behavior of the element, and an event with respect to the element.

The determination of whether the attributes of the element in the web document may be defined in the web redefining document comprises determining whether the attributes are defined by using at least one of a unique identifier of the element, an address of the element, a hash value of the element, and predetermined identification information based on the layout of the element.

The decision on the attribute of the element may comprise deciding on attributes of the element by using a new event freely defined in the web redefining document.

The web redefining document may be generated with respect to at least one element.

The decision on the attribute of the element may comprise, if attributes with respect to a group of allied elements comprising a plurality of elements of the same kind are defined in the web redefining document, unifying attributes of the elements in the group of allied elements.

The web redefining document may follow a format which can either be input or output and can be shared and exchanged among separate users.

The web redefining document may be generated by a predetermined tool for editing the web document.

According to another aspect of the present invention, there is provided a method of generating a web redefining document, the method comprising receiving a web document corresponding to the web redefining document; deciding on an element to be reset by user input from among elements included in the web document; identifying the decided on element; and setting attributes of the element.

Attributes of the element may define at least one of a layout of the element, a behavior of the element, and an event with respect to the element.

The identifying of the element may comprise identifying the element by using at least one of a unique identifier of the element, an address of the element, a hash value of the element, and predetermined identification information based on the layout of the element.

The method may further comprise freely defining new events.

The method may comprise deciding on at least one of elements included in the web document.

The deciding on the element may comprise deciding on a group of allied elements comprising a plurality of elements of the same kind, and the setting of the attributes of the element may comprise unifying attributes of the elements in the group of allied elements.

The web redefining document may follow a format which can either be input or output and can be shared and exchanged among separate users.

The web redefining document may be generated by a predetermined tool for editing the web document.

The setting of the attributes of the element may comprise setting attributes which can coexist with attributes of the element included in the web document.

The setting of the attributes of the element may comprise setting attributes which replace attributes of the element included in the web document.

According to another aspect of the present invention, there is provided an apparatus for reconstructing a web page by using a web redefining document, the apparatus comprising an input to which an externally received web document and a web redefining document generated by a user are input; a web redefining document browsing unit browsing to determine whether attributes of an element included in the web document are defined in the web redefining document; an attribute deciding unit deciding on attributes of the element based on a result of the browsing; and a web page constructing unit constructing the attributes of the element.

If a result of the browsing shows that attributes of the element are not defined in the web redefining document, the attribute deciding unit may comprise a maintenance deciding unit which decides to maintain attributes of an element defined in a web document.

If a result of the browsing shows that attributes of the element are defined in the web redefining document, the attribute deciding unit may comprise an alternative attribute deciding unit replacing attributes of the element with attributes defined in the web redefining document.

If a result of the browsing shows that attributes of the element are defined in the web redefining document, the attribute deciding unit may comprise a coexisting attribute deciding unit changing attributes of the element such that the element comprises both attributes defined in the web document and attributes defined in the web redefining document.

If attributes regarding the group of allied elements including a plurality of elements of the same kind are defined in a web redefining document, the attribute deciding unit may comprise an allied elements' attribute deciding unit (not shown) unifying attributes of elements in a group of allied elements.

According to another aspect of the present invention, there is provided an apparatus for generating a web redefining document, the apparatus comprising a web document input to which a web document corresponding to the web redefining document is input; an element deciding unit deciding on an element to be reset by user input from among elements included in the web document; an element identifying unit identifying the decided on element; and an attribute setting unit setting attributes of the element.

The attribute setting unit may comprise a coexisting attribute setting unit setting attributes of the element which can coexist with attributes of the element defined in the web document.

The attribute setting unit may comprise an alternative attribute setting unit setting attributes replacing attributes of the element defined in the web document.

The apparatus may further comprise a free event defining unit freely defining a new event not shown in a web document.

The element deciding unit may comprise an allied element deciding unit deciding on a group of allied elements including a plurality of elements of the same kind, and the attribute setting unit may comprise an allied elements' attribute deciding unit unifying attributes of elements in a group of allied elements.

According to another aspect of the present invention, there is provided a computer readable recording medium having recorded thereon a computer program for executing a method of reconstructing a web page by using a web redefining document, the method comprising receiving an external web document; receiving a web redefining document generated by a user; determining whether attributes of an element in the web document are defined in the web redefining document; deciding on attributes of the element based on the determination; and constructing a web page by using the decided on attributes of the element, wherein the attributes of the element are with respect to at least one of a layout of the element, a behavior of the element, and an event with respect to the element.

The decision on the attributes of the element may comprise changing attributes of the element to either attributes defined in the web document or attributes defined in the web redefining document.

According to another aspect of the present invention, there is provided a computer readable recording medium having recorded thereon a computer program for executing a method of generating a web redefining document, the method comprises deciding on an element to be reset by user input from among elements included in the web document corresponding to the web redefining document; identifying the decided element; and setting attributes of the element, wherein the attributes of the element are with respect to at least one of a layout of the element, a behavior of the element, and an event with respect to the element.

Attributes of the element may be changed to either attributes defined in the web document or attributes defined in the web redefining document.

### BRIEF DESCRIPTION OF THE DRAWINGS

The above and other features and advantages of the present invention will become more apparent by describing in detail exemplary embodiments with reference to the attached drawings, in which:

FIG. 1 is a block diagram of a web page constructing device using a web redefining document according to an exemplary embodiment of the present invention;

FIG. 2 is a block diagram of a web redefining document generating device according to an exemplary embodiment of the present invention;

FIG. 3 is a diagram illustrating a web document and elements and attributes defined by a web redefining document;

FIG. 4A is a diagram illustrating a change of elements of a web page by using a web redefining document according to an exemplary embodiment of the present invention;

FIG. 4B is a diagram illustrating a web page changed according to an exemplary embodiment of the present invention;

FIG. 5 is a diagram illustrating a change of elements of a web page by using a web redefining document according to another exemplary embodiment of the present invention;

FIG. 6 is a diagram illustrating a change of elements of a web page by using a web redefining document according to another exemplary embodiment of the present invention;

FIG. 7 is a flowchart illustrating a method of constructing a web page by using a web redefining document according to an exemplary embodiment of the present invention; and

FIG. 8 is a flowchart illustrating a method of generating a web redefining document according to an exemplary embodiment of the present invention.

### DETAILED DESCRIPTION OF EXEMPLARY EMBODIMENTS OF THE INVENTION

Before describing a web redefining document for constructing a web page according to the present invention, relevant terminology is partially defined below for convenience in explaining exemplary embodiments of the present invention.

A web document is a document for constructing a web page, and is a type of hypertext service provided via the web. In reality, the web provides information to a user via web documents. The web can display web content including multimedia, such as sounds, motion pictures, images, etc., as well as text. An example of a web document is a collection of characters according to the Hypertext Markup Lanuage (HTML) standard, and a web service embodied by web content is a result of re-interpreting a web document by a web browser which reads a document in HTML format.

‘Elements’ refers to construction aspects of a web page such as titles, paragraphs, lists, hypertext links, images, etc. in a HTML document. A HTML document may include elements such as an element ‘p’ designating paragraphs, an element ‘a’ for processing hyperlinks, an element IMG for inserting images, etc.

‘Attribute’ refers to content which defines a corresponding element. In a HTML document including an element ‘<a href=http://www.google.com>’, ‘a’ is a tag indicating a hyperlink, and ‘href’ is an attribute designating the location of the hyperlink. Here, the value of the attribute ‘href’ is ‘http://www.google.com.’

Referring to FIGS. 1 through 8, detailed descriptions of a method and an apparatus for constructing a web page using a web redefining document according to an exemplary embodiment of the present invention and detailed descriptions of a method and an apparatus for generating a web redefining document according to an exemplary embodiment of the present invention will be given below.

FIG. 1 is a block diagram of a web page constructing device using a web redefining document according to an exemplary embodiment of the present invention.

A web page constructing device 100 according to an exemplary embodiment of the present invention comprises an input unit 110 via which a web document and a web redefining document are input, a web redefining document browsing unit 120, an attribute deciding unit 130, and a web page constructing unit 140.

An externally received web document and a web redefining document generated by a user are input to the input unit 110 and are output to the web redefining document browsing unit 120. The web redefining document generated by a user comprises content corresponding to the web document.

A web redefining document is a document for reconstructing a web page by redefining elements already defined in a web document, and may also be referred to as a template. Definitions regarding construction of a web page written in a web document may be referred to as first definitions and the web document may be referred to as a first definition document. In this regard, the web redefining document may be referred to as a second definition document, and definitions of elements written in the web redefining may be referred to as second definitions.

The web redefining document browsing unit 120 receives a web document and a web redefining document from the input unit 110 and figures out whether attributes of elements included in the web document are defined in the web redefining document.

The web redefining document browsing unit 120 can figure out whether attributes of an element are defined in a web redefining document or not by using at least one of a unique identifier, an address, a hash value, and predetermined identification information, which is based on a layout of the element, of the element.

Attributes of an element may contain content which defines at least one event of the element, such as layout and operation of the element.

The attribute deciding unit 130 decides on attributes of an element according to a browsing result of the web redefining document browsing unit 120, and outputs the decided on attributes to the web page constructing unit 140.

The attribute deciding unit 130 may include an attribute maintenance deciding unit (not shown) which decides to maintain attributes of an element defined in a web document in the case where a result of browsing performed by the web redefining document browsing unit 120 indicates that attributes of the element are not defined in a web redefining document.

The attribute deciding unit 130 may include an alternative attribute deciding unit (not shown) replacing attributes of the element with other attributes of the element defined in a web redefining document if attributes of the element are defined in the web redefining document. Furthermore, the attribute deciding unit 130 may include a coexisting attribute deciding unit (not shown) for changing attributes of an element which has attributes including attributes defined in both a web document and a web redefining document.

The attribute deciding unit 130 may include an allied elements attribute deciding unit (not shown) unifying attributes of elements in a group of allied elements if attributes regarding the group of allied elements including a plurality of elements of the same kind are defined in a web redefining document.

If a new event, which is not defined in a web document, is defined in a web redefining document, the attribute deciding unit 130 may decide on attributes of an element by using the new event.

The web page constructing unit 140 constructs a web page by using attributes of an element decided on by the attribute deciding unit 130.

One web redefining document may be generated for each element, or at least one element may be recorded in one web redefining document.

A web redefining document may follow a format so that the web redefining document can be either externally input or output to be shared and exchanged between separate users. Sharing of web definition documents between users may improve user satisfaction regarding a web page by using optimized or customized layouts. A web content creator may enhance a user interface by using feedback regarding a web page reconstructed by using a web redefining document.

A web redefining document can be generated by using web authoring tools such as a web editor. In this case, it is not necessary to decide on an address, a hash value, an identifier, etc. of an element in order to identify the element. Instead, attributes of an element may be decided on by directly designating the element.

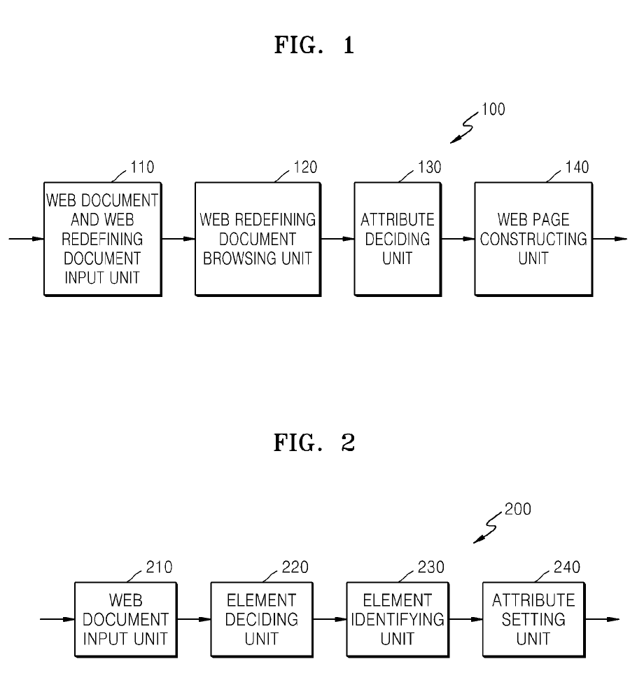

FIG. 2 is a block diagram of an apparatus 200 for generating a web redefining document according to an exemplary embodiment of the present invention.

The apparatus 200 includes a web document input unit 210, an element deciding unit 220, an element identifying unit 230, and an attribute setting unit 240.

A web document corresponding to a web redefining document to be generated is input to the web document input unit 210. The web redefining document may reconstruct a web page constructed by the web document by redefining elements on the input web document.

The element deciding unit 220 decides which elements have attributes which are to be redefined by user input from among all the elements included in the web document input via the web document which was input unit 210, and outputs the decided on elements to the element identifying unit 230. The element deciding unit 220 may decide on only one of elements included in a web document. Furthermore, the element deciding unit 220 may decide on a plurality of elements from among elements included in a web document.

An example of the element deciding unit 220 may include an allied element deciding unit (not shown) deciding on a group of allied elements by selecting one or more elements of the same kind.

The element identifying unit 230 identifies elements decided on by the element deciding unit 220. An element can be identified by using at least one of a unique identifier, an address, a hash value, and predetermined identification information of the element, wherein the predetermined identification information is based on a layout of the element. The predetermined identification information may be identification information according to a position and size of the element in a layout.

In the case where a web redefining document is generated by using a predetermined web authoring tool, a user may not need to know values of identification information of an element, and may directly decide on a desired element.

The attribute setting unit 240 sets attributes of an element decided on by the element deciding unit 220 and identified by the element identifying unit 230. The attribute setting unit 240 may define attributes of an element.

An example of the attribute setting unit 240 may include a coexisting attribute setting unit (not shown) setting attributes of an element such that the attributes can coexist with other attributes of the element in a web document. Furthermore, the attribute setting unit 240 may include an alternative attribute setting unit (not shown) setting attributes of an element for replacing other attributes of the element in a web document.

In the case where the attribute deciding unit 220 includes the allied element deciding unit (not shown) deciding on a group of allied elements including elements of the same kind, the attribute setting unit 240 may include an allied attribute setting unit (not shown) unifying attributes of elements in a group of allied elements.

Although not shown in FIG. 2, the apparatus 200 may further include a free event defining unit freely defining a new event not shown in a web document.

The type of a web browser, the size of a monitor display device, and the performance of a computer vary between users, and preferences, needs, and environments also vary between users. Furthermore, although HTML, CSS, and JavaScript used in a web document are easy to use, web content serviced by a commercial web document can only be edited by a developer of the web content. A user is not authorized to change layout and method of operation of a commercial web page.

In this case, elements and attributes of the element, which are defined by a user, can be embodied on a web page by using a web redefining document according to embodiments of the present invention.

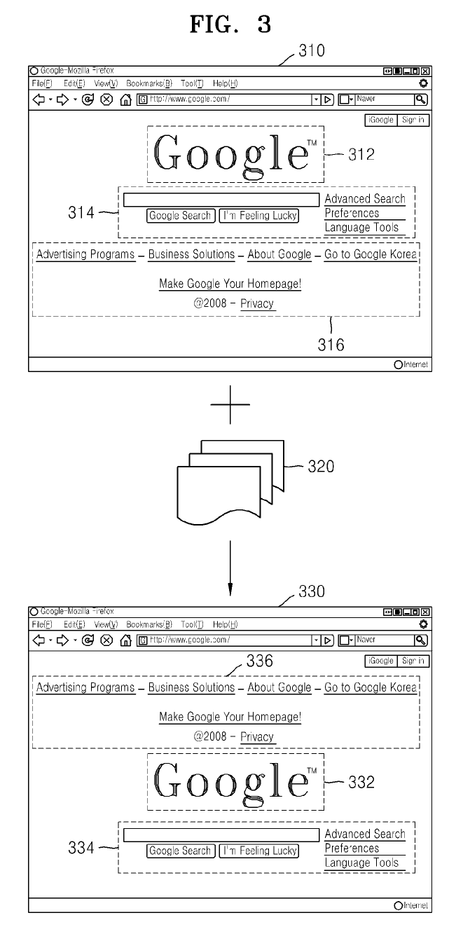

FIG. 3 is a diagram illustrating elements and attributes of the elements that are decided by a web document and a web redefining document.

An external web document and a web redefining document 320 from a user are input to the input unit 110 of the web page constructing device 100. The web document and the web redefining document 320 may define layouts, behaviors, and events of web content by using programming languages such as HTML, CSS, and JavaScript.

A first web page 310 is a web page constructed by using an externally received web document. The first web page 310 includes a first element 312, a second element 314, and a third element 316. Attributes with respect to the first through third elements 312, 314, and 316 of the first web page 310 are defined in the web redefining document 320. Although a plurality of web redefining documents 320 are shown in FIG. 3, there may be only one web redefining document.

The web redefining document browsing unit 120 figures out whether the web redefining document 320 redefines attributes of elements 312, 314, and 316 in the web document or not, and confirms that the web document includes attributes with respect to the first through third elements 312, 314, and 316.

Since attributes with respect to the first through third elements 312, 314, and 316 are defined in the web redefining document 320, the alternative attribute deciding unit of the attribute deciding unit 220 replaces attributes with respect to the first through third elements 312, 314, and 316 with the attributes defined in the web redefining document 320.

The web page constructing unit 140 constructs a second web page 330 by using elements and attributes of the elements decided by considering the web document and the web redefining document 320. Specifically, the elements 312, 314, and 316 redefined by the web redefining document 320 are embodied on the second web page 330 with new alternative attributes. In other words, layouts of the elements 312, 314, and 316 are changed such that a third′ element 336, a first′ element 332, and a second′ element 334 are sequentially arranged on the second web page 330.

The web redefining document 320 is generated by the apparatus 200 for generating a web redefining document according to an exemplary embodiment of the present invention. The element deciding unit 220 selects the first through third elements 312, 314, and 316 of the first web page 310 as elements of which attributes are to be redefined. The element identifying unit 230 uses an address (i.e., uniform resource locator (URL)), a hash value, or an identifier of each of the elements 312, 314, and 316 to identify each of the elements 312, 314, and 316.

The attribute setting unit 240 redefines attributes in the web redefining document 320, the attributes with respect to the first through third elements 312, 314, and 316 of the first web page 310. The attribute setting unit 240 designates each of the elements 312, 314, and 316 by using identifiers of the elements 312, 314, and 316 obtained by the element identifying unit 230, and redefines attributes of each of the elements 312, 314, and 316 such that the elements 312, 314, and 316 are embodied as the third′ element 336, the first′ element 332, and the second′ element 334 in the second web page 330.

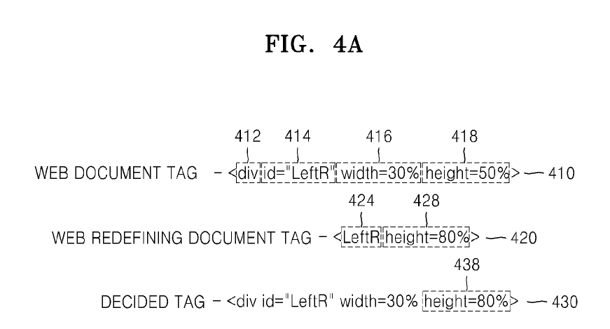

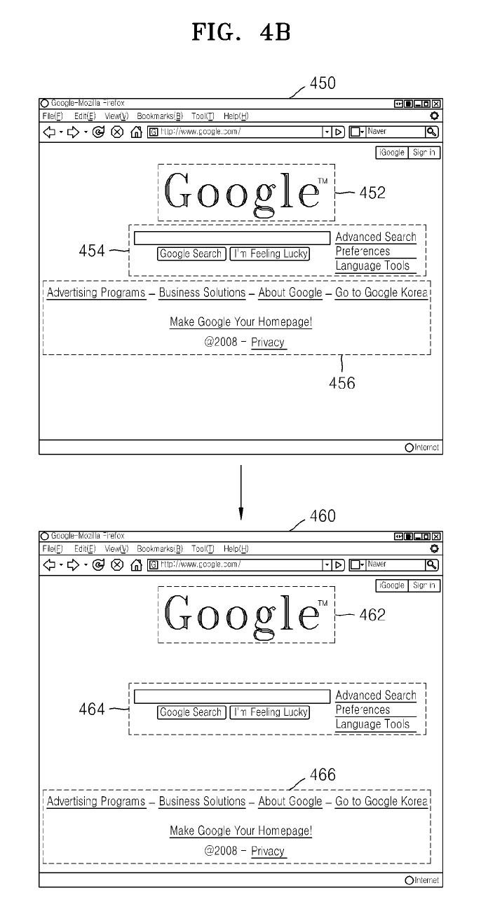

Referring to FIGS. 4A, 4B, 5, and 6, a web redefining document for the web page constructing device 100 and the apparatus 200 for generating a web redefining document will be described below in detail. Although HTML language is used in an exemplary embodiment below for convenience of explanation, the present invention is not limited thereto, and exemplary embodiments of the present invention can be embodied by using various languages other than HTML.

FIG. 4A is a diagram illustrating an example of changing elements of a web page by using a web redefining document.

A web document tag 410, which is a tag in an externally received web document, defines attributes with respect to an element ‘div’ 412, wherein the ‘div’ is the element for dividing a screen, which displays the web page based on the web document. The ‘div’ 412 in the web document tag 410 has a ‘LeftR’ value 414 for an attribute ‘id’ for identifying the divided screen, a ‘30%’ value 416 for an attribute ‘width’ indicating the width of the divided screen, and a ‘70%’ value 418 for an attribute ‘height’ indicating the height of the divided screen.

A web redefining document tag 420, which is a tag in a web redefining document created by a user, defines an ‘80%’ value 428 for the attribute ‘height’ with respect to an element 424 for dividing the screen having the ‘LeftR’ value 414. The element deciding unit 220 of the apparatus 200 selects the element ‘div’ 412, and the element identifying unit 230 identifies the element ‘div’ having an id ‘LeftR’ 424. The attribute setting unit 240 sets the attribute ‘height’ of the element ‘div’ 412 having the id ‘LeftR’ 424 as the ‘80%’ value 428.

The web redefining document browsing unit 120 of the web page constructing device 100 browses the web redefining document and confirms that the web redefining document tag 420 with respect to the element ‘div’ 412 is included. Furthermore, the web redefining document browsing unit 120 identifies the element ‘div’ 412 using the id ‘LeftR’ 424. The attribute deciding unit 130 may finally decide a value 438 for the attribute ‘height’ in a decided tag 430 by replacing the value 418 of the attribute ‘height’ defined in the web document tag 410 with the value 428 of the attribute ‘height’ defined in the web redefining document tag 420 with respect to the element ‘div’ having the id ‘LeftR’ 424.

FIG. 4B is a diagram illustrating a web page changed according to an exemplary embodiment of the present invention.

A third web page 450 constructed by a web document comprises a fourth element 452, a fifth element 454, and a sixth element 456, that are the elements ‘div’ for dividing screen. In the case where the fifth element 454 is an element identified by an id ‘LeftR’ 414, an attribute ‘height’ of the fifth element 454 is changed from ‘50%’ to ‘80%’ by the web redefining document tag 420.

Therefore, a fourth web page 460 constructed by using a web document and a web redefining document comprises a fourth′ element 462 and a sixth′ element 466 that are identical to the fourth element 452 and the sixth element 456 in the first web page 450, and further comprises a fifth′ element 464 with changed height.

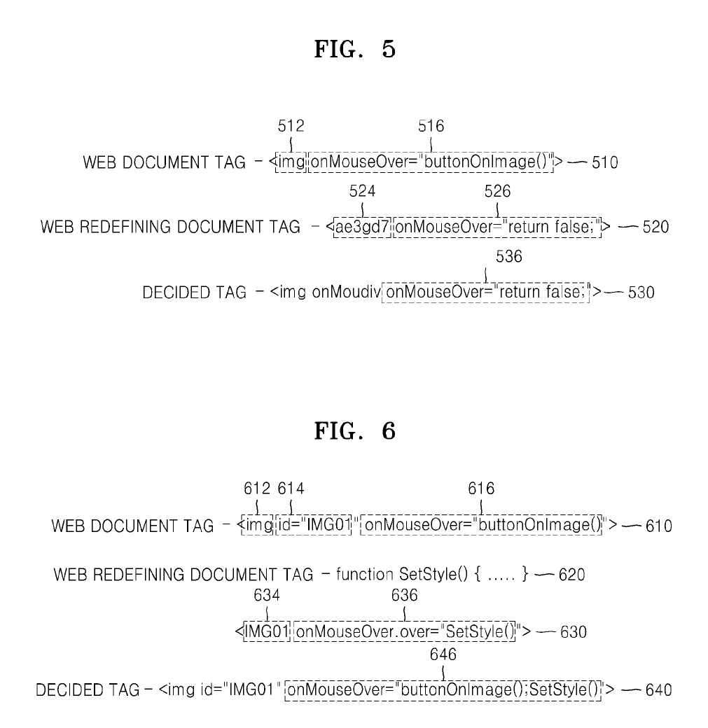

FIG. 5 is a diagram for explaining changing of elements of a web page by using a web redefining document according to another exemplary embodiment of the present invention.

A web document tag 510 defines attributes with respect to an element ‘img’ 512 for displaying an image. The element ‘img’ 512 includes an attribute ‘on MouseOver’ having a value ‘buttonOnImage’ 516 for events occurring when a mouse is clicked on an image.

The element deciding unit 220 of the apparatus 200 selects the element ‘img’ 512, and the element identifying unit 230 uses an identifier ‘ae3gd’ 524 to identify the element ‘img’ 512. If there is no identifier for an element, the address of the element may be used instead. The attribute setting unit 240 sets a value ‘return false;’ 526 to the attribute ‘on MouseOver’ of the element ‘img’ 512 having the identifier ‘ae3gd’ 524.

The web redefining document browsing unit 120 of the web page constructing device 100 browses the web redefining document and confirms that a web redefining document tag 520 with respect to the element having the identifier ‘ae3gd’ 524 is included. With respect to the element ‘img’ 512 having the identifier ‘ae3gd’ 524, the attribute deciding unit 130 may make a final decision for a value 536 of the attribute ‘on MouseOver’ in a decided tag 530 by replacing a value 516 of the attribute ‘on MouseOver’ in the web document with the value 526 of the attribute ‘on MouseOver’ defined in the web redefining document tag 520.

FIG. 6 is a diagram for explaining changing of elements of a web page by using a web redefining document according to another exemplary embodiment of the present invention.

A web document tag 610 defines attributes with respect to an element ‘img’ 612. The element ‘img’ 612 in the web document tag 610 has an ID ‘IMG01’ 614, and an attribute ‘on MouseOver’ of the element ‘img’ 612 has a value ‘buttonOnImage( )’ 616.

The apparatus 200 may define a new event in a web redefining document, wherein the new event not defined in a web document. For example, the apparatus 200 may define a tag 620 newly defining an event ‘SetStyle( ),’ which is an event for setting styles of an element.

Although the attribute setting unit 240 can set attributes to replace attributes of a predetermined element, the attribute setting unit 240 can also set (‘.over’) attributes to coexist with attributes in a web document. For example, the attribute setting unit 240 may add a tag 630 setting an event ‘SetStyle( )’ to coexist with the attribute ‘on MouseOver’ of the element ‘img’ 612 having the id ‘IMG01’ 614 to a web redefining document.

The web redefining document browsing unit 120 of the web page constructing device 100 browses the web redefining document and confirms that a web redefining document tag 630 with respect to the element having the identifier ‘IMG01’ 634 is included.

The attribute deciding unit 130 may decide whether attributes defined in the web redefining document tag 420 are attributes to be replaced or attributes that are to coexist with other attributes. With respect to attributes defined as ‘.over ’, the attribute deciding unit 130 sets the attribute ‘on MouseOver’ with respect to the element ‘img’ 612 having the ID ‘IMG01’ 614 such that the value 616 of the attribute ‘on MouseOver’ in the web document can coexist with the event ‘SetStyle’ 636 newly defined in the web redefining document tag 630.

Thus, the decided tag 630 defines ‘buttonOnImage( );SetStyle( )’ 646, in which attributes respectively having the value 616 and the value 636 coexist, with respect to the element ‘img’ 612 having the ID ‘IMG01’ 614. Thus, both of the events ‘buttonOnImage( )’ and ‘SetStyle( )’ occur on a web page constructed by the web page constructing unit 140.

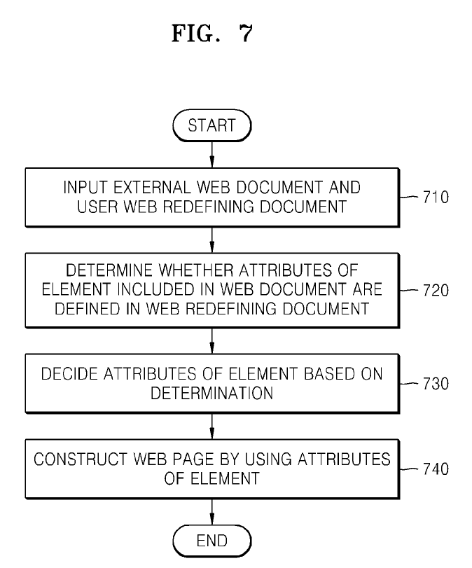

FIG. 7 is a flowchart of a method of constructing a web page by using a web redefining document according to an exemplary embodiment of the present invention.

In operation 710, an externally received web document and a web redefining document generated by a user are input.

In operation 720, it is determined whether attributes of an element in the web document are defined in the web redefining document. The web redefining document may use an address, an ID, a hash value, and identification information regarding layout to identify an element in the web document.

In operation 730, attributes of the element are decided based on the determination of operation 720. In the case where attributes of the element are defined in the web redefining document, the attributes defined in the web redefining document may be decided as final attributes instead of attributes defined in the web document, or final attributes may be decided such that the attributes defined in the web redefining document and the attributes defined in the web document coexist.

In operation 740, a web page is constructed by using the attributes of the element. A web page constructed by using an externally supplied web document can be reconstructed according to preferences and/or needs of a user by using a web redefining document generated by a user.

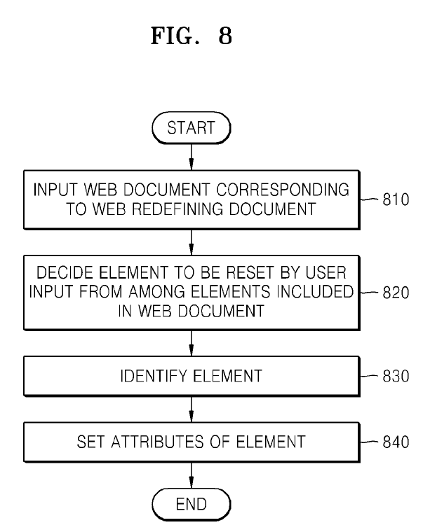

FIG. 8 is a flowchart of a method of generating a web redefining document according to an exemplary embodiment of the present invention.

In operation 810, a web document corresponding to a web redefining document is input.

In operation 820, an element of which attributes are to be reset by a user is selected from among elements included in the web document.

In operation 830, the decided element is identified by using identification information to identify the element, or by directly selecting the element even if a user does not know identification information of the element in the case where the user uses tools such as a web editor.

In operation 840, attributes of the element are decided. Although attributes and events applied in the web document may be used to reset the attributes of the element, the web redefining document may define new attributes and events.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs). In other exemplary embodiments, the computer readable recording medium may include storage media such as carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of constructing a web page by using a web redefining document, the method comprising:
receiving an external web document and a web redefining document generated by a user;
determining in a determination, whether attributes of an element in the external web document are defined in the web redefining document;
deciding on the attributes of the element based on the determination; and
constructing a web page by using the decided on attributes of the element.

2. The method of claim 1, wherein the deciding on the attributes of the element comprises maintaining the attributes of the element, if attributes of the element are not defined in the web redefining document.

3. The method of claim 1, wherein the deciding on the attributes of the element comprises replacing the attributes of the element with attributes defined in the web redefining document, if the attributes of the element are defined in the web redefining document.

4. The method of claim 1, wherein the deciding on the attributes of the element comprises changing the attributes of the element such that the element comprises both the attributes defined in the external web document and the attributes defined in the web redefining document, if the attributes of the element are defined in the web redefining document.

5. The method of claim 1, wherein the attributes of the element define at least one of a layout of the element, a behavior of the element, and an event with respect to the element.

6. The method of claim 1, wherein the determining of whether the attributes of the element in the external web document are defined in the web redefining document comprises determining whether the attributes are defined by using at least one of a unique identifier of the element, an address of the element, a hash value of the element, and predetermined identification information based on a layout of the element.

7. The method of claim 1, wherein the deciding on the attributes of the element comprises deciding on the attributes of the element by using a new event freely defined in the web redefining document.

8. The method of claim 1, wherein the web redefining document is generated with respect to at least one element.

9. The method of claim 1, wherein the deciding on the attributes of the element comprises, if attributes with respect to a group of allied elements comprising a plurality of elements of a kind are defined in the web redefining document, unifying attributes of the plurality of elements in the group of allied elements.

10. The method of claim 1, wherein the web redefining document follows a format which can either be input or output and can be shared and exchanged among separate users.

11. The method of claim 1, wherein the web redefining document is generated by a predetermined tool for editing the external web document.

12. A method of generating a web redefining document, the method comprising:
receiving a web document corresponding to the web redefining document;
deciding on an element to be reset by user input from among elements included in the web document;
identifying the decided on element; and
setting attributes of the element.

13. The method of claim 12, wherein attributes of the element define at least one of a layout of the element, a behavior of the element, and an event with respect to the element.

14. The method of claim 12, wherein the identifying of the element comprises identifying the element by using at least one of a unique identifier of the element, an address of the element, a hash value of the element, and predetermined identification information based on the layout of the element.

15. The method of claim 12, further comprising freely defining a plurality of new events.

16. The method of claim 12, wherein the deciding on the element comprises deciding on a group of allied elements comprising a plurality of elements of a kind, and
the setting of the attributes of the element comprises unifying attributes of the plurality of elements in the group of allied elements.

17. The method of claim 12, wherein the web redefining document follows a format which can either be input or output and can be shared and exchanged among separate users.

18. The method of claim 12, wherein the web redefining document is generated by a predetermined tool for editing the web document.

19. The method of claim 12, wherein the setting of the attributes of the element comprises setting attributes which can coexist with attributes of the element included in the web document.

20. The method of claim 12, wherein the setting of the attributes of the element comprises setting attributes which replace attributes of the element included in the web document.

21. An apparatus for reconstructing a web page by using a web redefining document, the apparatus comprising:
an input to which receives an externally received web document and a web redefining document generated by a user;
a web redefining document browsing unit which browses to determine whether attributes of an element included in the externally received web document are defined in the web redefining document;
an attribute deciding unit which decides on attributes of the element based on a result of the browsing; and
a web page constructing unit which constructs the attributes of the element.

22. The apparatus of claim 21, wherein, if a result of the browsing shows that attributes of the element are defined in the web redefining document, the attribute deciding unit comprises:
an alternative attribute deciding unit replaces attributes of the element with attributes defined in the web redefining document; and
a coexisting attribute deciding unit which changes attributes of the element such that the element comprises both attributes defined in the externally received web document and attributes defined in the web redefining document.

23. An apparatus for generating a web redefining document, the apparatus comprising:
a web document input which receives a web document corresponding to the web redefining document;
an element deciding unit which decides on an element to be reset by user input from among elements included in the web document;
an element identifying unit which identifies the decided on element; and
an attribute setting unit which sets attributes of the element.

24. The apparatus of claim 23, the attribute setting unit comprising:
a coexisting attribute setting unit which sets attributes of the element which can coexist with attributes of the element defined in the web document; and
an alternative attribute setting unit which sets attributes replacing attributes of the element defined in the web document.

25. A computer readable recording medium having recorded thereon a computer program for executing a method of reconstructing a web page by using a web redefining document, the method comprising:
receiving an external web document;
receiving a web redefining document generated by a user;
determining in a determination, whether attributes of an element in the external web document are defined in the web redefining document;
deciding on the attributes of the element based on the determination; and
constructing a web page by using the decided on attributes of the element,
wherein the attributes of the element are with respect to at least one of a layout of the element, a behavior of the element, and an event with respect to the element.

26. The computer readable recording medium of claim 25, wherein the deciding on the attributes of the element comprises changing attributes of the element to either attributes defined in the external web document or attributes defined in the web redefining document.

27. A computer readable recording medium having recorded thereon a computer program for executing a method of generating a web redefining document, the method comprises:
deciding on an element to be reset by user input from among elements included in the web document corresponding to the web redefining document;
identifying the decided on element; and
setting attributes of the element,
wherein the attributes of the element are with respect to at least one of a layout of the element, a behavior of the element, and an event with respect to the element.

28. The computer readable recording medium of claim 27, wherein attributes of the element are changed to either attributes defined in the web document or attributes defined in the web redefining document.

29. A web redefining document for reconstructing a web page based on a web document, comprising:
a plurality of redefining elements corresponding to a plurality of elements in a web document such that each element has at least one of a unique identifier, an address, a hash value, and predetermined identification information; and
a plurality of definitions for redefining a plurality of attributes for defining a corresponding element of the web document based on the unique identifier, address, hash value, or predetermined identification information.

30. The web redefining document of claim 29, wherein the predetermined identification information is based on a layout of the element.

31. The web redefining document of claim 29, wherein the predetermined identification information is a position of the element and size of the element in a layout.

32. The web redefining document of claim 29, wherein the attribute defines at least one of a layout, a behavior, and an event corresponding to an element.
